(19) United States
(12) Patent Application Publication
(10) Pub. No.: US 2016/0242372 A1
(43) Pub. Date: Aug. 25, 2016

(54) PHOTOSYNTHETICALLY ACTIVE LIGHTING UNDER PLANT LEAVES

(71) Applicant: Aessense Technology Hong Kong Limited, Harbour City (HK)

(72) Inventors: Simon Wong, Los Altos, CA (US); Huafang Zhou, San Jose, CA (US)

(21) Appl. No.: 15/048,811

(22) Filed: Feb. 19, 2016

Related U.S. Application Data
(60) Provisional application No. 62/118,871, filed on Feb. 20, 2015.

(51) Int. Cl. A01G 31/02; A01G 1/00; A01G 7/04

(52) U.S. Cl. CPC A01G 31/02; A01G 7/045; A01G 1/001

(57) ABSTRACT

A hydroponic system provides photosynthetic light intensities from below a plant, e.g., underneath the leaves of the plant, to accelerate the photosynthesis process in plants. The hydroponic system may further include gas supply tubes underneath the leaves and the gas supply tubes may be integrated with an under-lighting system. The under-leaf lighting system can be used with lighting from above the plant, e.g., direct sunlight or through artificial lighting, to increase the total plant area exposed to light suitable for photosynthesis.

### BACKGROUND

Plants use photosynthesis to convert light energy into chemical energy that allows plants to grow. More particularly, photosynthesis uses light energy to synthesize carbohydrate molecules, such as sugars, from carbon dioxide and water. Plants in nature receive light from the sun and use the sunlight in photosynthesis. Hydroponic systems have been developed that allow growing of plants indoors without sunlight and traditionally use lighting systems above plants to provide light for photosynthesis.

### SUMMARY

In accordance with an aspect of the invention, a hydroponic system provides photosynthetic light intensities from below a plant, e.g., underneath the leaves of the plant, to accelerate the photosynthesis process in plants. The under-leaf light can be used with lighting from above the plant, e.g., sunlight or artificial lighting directed onto the tops of leaves, to increase the total plant area exposed to light suitable for photosynthesis. The under-leaf lighting also provides a compact hydroponic system since the lighting can be mounted on structures that hold the roots of plants. Gas lines may be provided with the under-leaf lighting, for example, to provide ventilation, air flow, or carbon dioxide that when combined with the additional light may increase the total photosynthesis in the plant.

In one configuration, a hydroponic system uses customized LED panels to supply light from beneath the leaves of plants during the growth cycle of the plants. An under-leaf lighting system may include a first set of LED panels mounted on a configuration tray or other structure that holds the root system of one or more plants, and the first set of LED panels may be positioned to direct light at the undersides of the leaves of the one or more plants. The LED panels may be laminated to improve water resistance, and the laminated structure may be glued or otherwise affixed using any number of methods to a planting fixture. An optional above-plant lighting system may include a second set of LED panels that may be mounted above the one or more plants and may be positioned to direct light onto the tops of the leaves of the one or more plants. Lighting from both above and beneath the plant leaf may increase photosynthesis without using an excessive light intensity that might damage the upper surfaces of plants may be able to handle. If other plant growth criterion such as nutrients and carbon dioxide are provided to a growing plant, increasing the area of plant surface exposed to light for photosynthesis may encourage and promote healthy plant growth.

In accordance with a further aspect of the invention, under-leaf lighting can be provided with or even integrated into a gas line or tube connected to a system that vents or supplies gas and other vapors including carbon dioxide under the leaves of plants.

### BRIEF DESCRIPTION OF THE DRAWINGS

FIG. 1A shows a hydroponic system having net pots mounted on a configuration tray.

FIG. 1B shows an implementation of the system of FIG. 1A after addition of under-leaf lighting and gas lines.

FIG. 2 shows an implementation of a hydroponic system with under-leaf lighting and above-plant lighting.

The drawings illustrate examples for the purpose of explanation and are not of the invention itself. Use of the same reference symbols in different figures indicates similar or identical items.

### DETAILED DESCRIPTION

A system for growing plants can provide lighting to both the top side and bottom side of the plant, e.g., above-plant lighting and under-leaf lighting. The under-leaf or above-plant lighting may be artificial and may provide lighting having a duty cycle, an intensity and frequency spectrum selected to optimize photosynthesis and the plant's growth. The system may thus provide better growth than natural environments since under-leaf lighting does not normally occur in nature. The system may also provide better growth than artificial environments that only provide lighting from the top down onto plants.

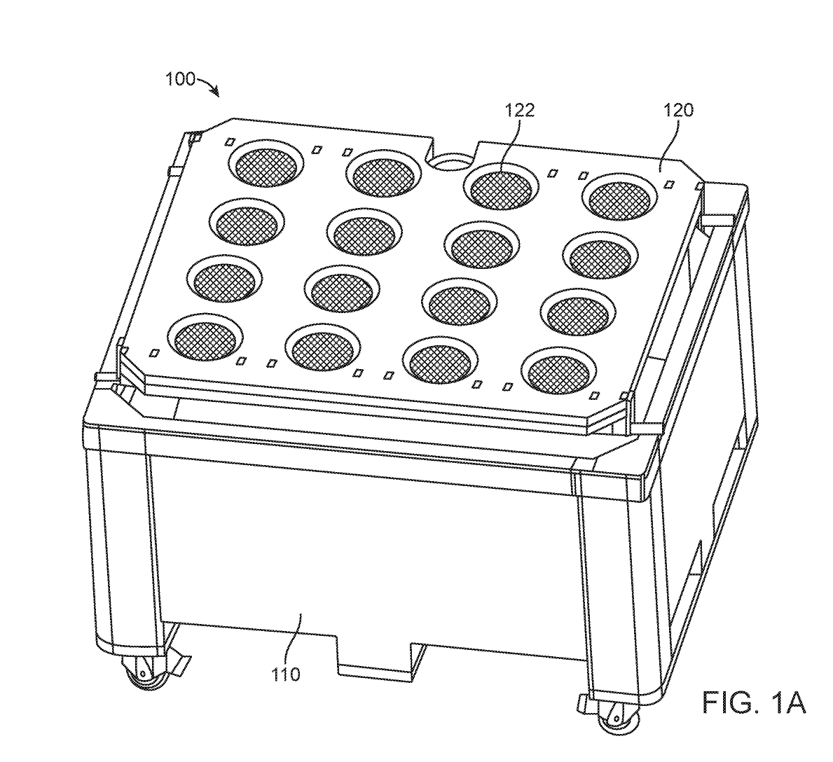

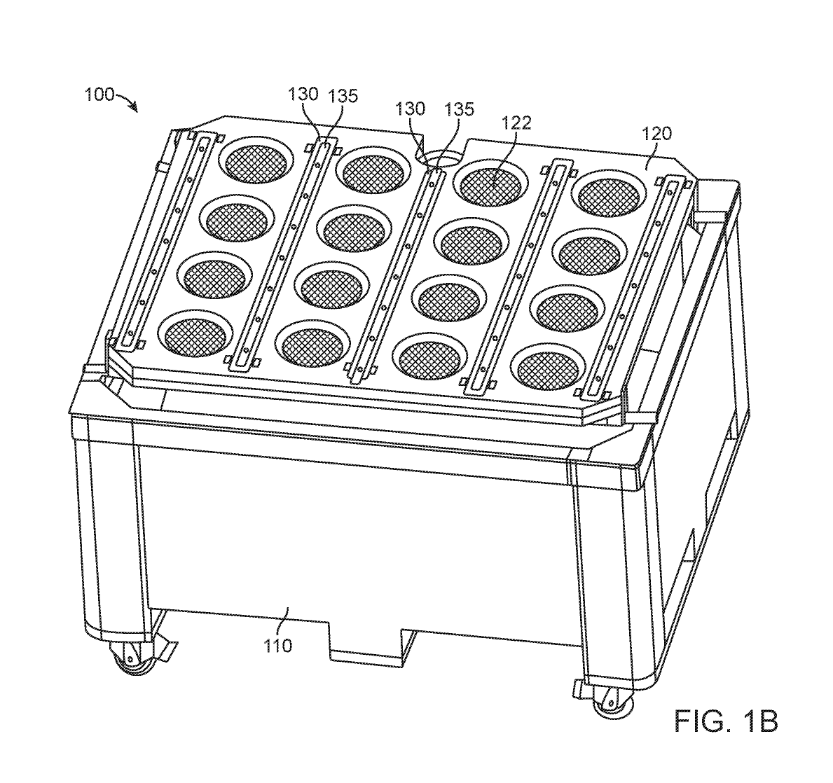

In an enclosed hydroponic growth system, plants may be positioned in net pots contained in a configuration tray panel, and under-leaf light can be implemented in or mounted on a configuration tray. FIG. 1A, for example, shows a hydroponic system 100 that may include a reservoir 110 and a configuration tray 120. Configuration tray 120 acts as a top or cover for reservoir 110 and contains one or more plant fixtures 122, e.g., net pots. Configuration tray 120 may be replaceable or reconfigurable to change the number, size, or spacing of plant fixtures 122, for example, to accommodate plants having a different size or different rooting needs. Each plant fixtures 122 provides a structure capable of holding a plant, particularly the roots of a plant, during growth and may be, for example, a basket-type device through which the roots of the plant extend down towards the bottom of reservoir 110. The stalk and leaves of a plant in a plant fixture 122 generally extend above tray 120. Reservoir 110 may contain water or an aqueous nutrient solution. In some hydroponic applications, reservoir 110 contains the aqueous nutrient solution at a level that at least partially submerges the roots of plants that fixtures 122 hold. In an aeroponic use, reservoir 110 may contain a low level of water or solution but provides an enclosed volume for the roots to occupy. For example, reservoir 110 may contain a level of nutrient solution below the deepest roots of the plants, which hang from net pots and are surrounded by air, and hydroponic system 100 may supply the nutrient solution to misters that apply droplets of nutrient solution to the plants' roots.

System 100 may further contain a control system, a wireless communication system, and various canisters, pumps, and other systems for storing and mixing nutrients for growing plants. More generally, FIG. 1A only illustrates an example implementation of hydroponic system 100. Other implementations may include any known hydroponic system or sub-systems, may be constructed using conventional designs and techniques, and may be improved as described herein through addition of under-leaf lighting.

FIG. 1B, for example, shows system 100 with under-leaf lighting mounted on configuration tray 120. The under-leaf lighting may particularly include LED strips 130 positioned along lines between rows or columns of pot centers 122. The number of strips 130 can vary with implementation. Each strip 130 may include a set or collection of LEDs selected or tuned in spectrum or frequency for plant growth and more specifically tuned in spectrum for lighting the underside of the leaves of one or more plants. Further, in a programmable configuration, each strip 130 may contain LEDs of different types, e.g., different frequencies of peak emissions, and a control system (not shown), e.g., a computer executing a program, can control the LEDs to provide under-leaf lighting with a spectral distribution, a period or duration, and an intensity tailored for the underside of leaves or other portions of the specific plant or plants being illuminated. LEDs may be a beneficial source of light in strips 130 because LEDs may be selected to produce the correct spectrum and intensity for photosynthesis and because LEDs produce less heat than most other light sources. Still other light sources could alternatively be used. Reflectors, mirrors, or light deflectors on tray 120 may be employed, but under-leaf lighting that directs light directly onto the underside of leaves may be more energy efficient.

LED strips 130 may be mounted on configuration tray 120 through a process of lamination or other waterproofing processes to make strips impervious to water or other contaminates, which may be provided to the plants at the net pots 122. For example, an aeroponic system may apply a mist or spray of water or nutrient solution to the plant roots in net pots 122, and LED strips 130 may be constructed for use where mist or spray might contact LED strips 130. The lamination of the LEDs and wiring of strips 130 may be integrated as part of configuration tray 120. For example, a manufacturing process may place LEDs and wiring on support structure of tray 120, and a clear layer or protective membrane may be affixed, e.g., glued or fused onto the support structure. The membrane may be fully water and contamination proof to protect LEDs and wiring from moisture or corrosive solution. In the illustrated configuration, under-leaf gas lines or tubes 135 may be affixed with the LEDs under, atop, or adjacent to the membrane attached to tray 120. In one implementation, gas tubes 135 may include vent holes and may supply carbon-dioxide or other gases, e.g., form a tank (not shown) or supply of air containing carbon dioxide or other gases. In another implementation, gas tubes 135 may include an inflatable tube or bladder made of a fabric or other porous material, so that when gas tubes 135 are inflated with a supply gas such as air or carbon dioxide, gas tubes 135 leak the supply gas under the leaves of plants being grown. Alternatively, gas tubes 135 may vent or draw gas or air away from under the plants, or a gas or air flow may be supplied or drawn through openings associated with net pots 122.

Gas tubes 135 in one implementation are small tubes that are laminated onto configuration tray 120 and made waterproof. Carbon-dioxide gas or air flow injected through gas tubes 135 may then be introduced to the underside or the “normally shaded” side of the plants, or air flow may be provided to the underside of the leaves by drawing gas from under the plants through gas tube 135. The underside of plants commonly suffers from CO₂ and light deprivation, and therefore may not grow as well as the upper portions of the plants. Supplying light and CO₂ to the underside may thus be beneficial to many types of plants.

Under-leaf lighting systems, e.g., LED strips 130, provide the lighting upwards to the underneath surfaces of plants, and under-leaf gas supply systems supply gas such as CO₂ from beneath the leaves of plants. The terminology “under-leaf” plant surfaces is used herein to include any underneath surfaces and not to be limited to leaves or plants having leaves. Such under-leaf lighting or gas supply may be used with conventional lighting or gas supply above the plants in net pots 122. For example, hydroponic system 100 may be exposed to artificial overhead lighting or natural sunlight, e.g., direct or through skylights or windows predominantly onto the top surfaces of plants.

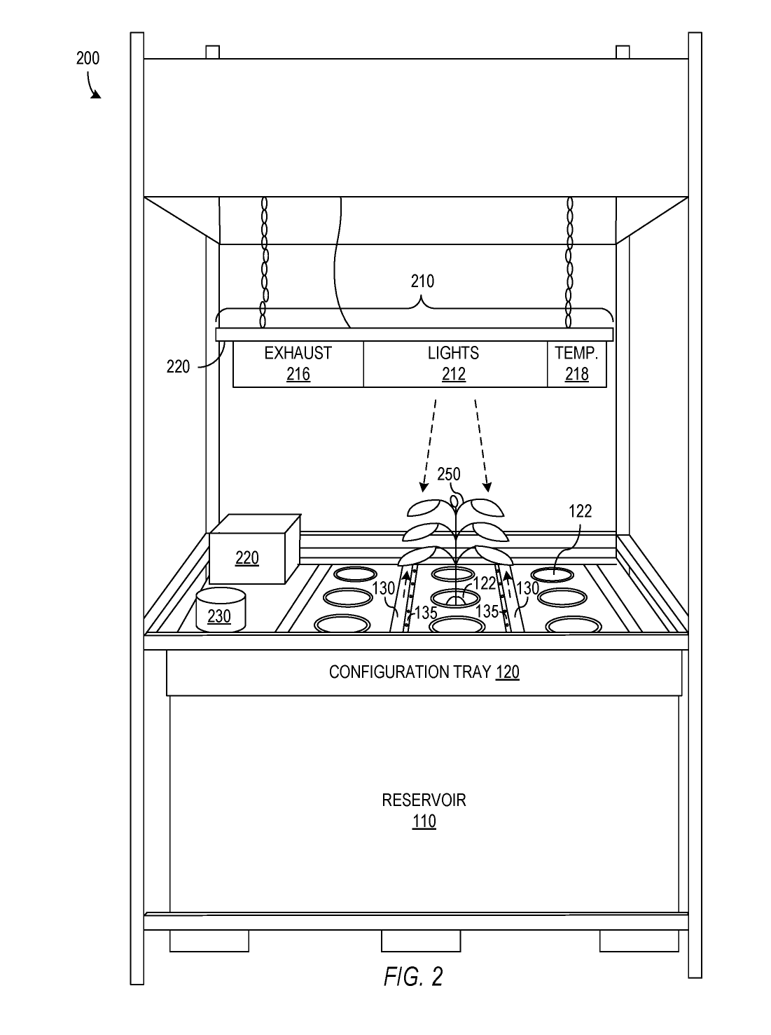

An enclosed hydroponic system may however provide both under-leaf lighting and above-plant lighting. FIG. 2 shows a hydroponic system 200 including both under-leaf lighting and above-plant lighting. As shown in FIG. 2, an above-plant portion 210 of hydroponic system 200 may include lighting equipment 212, an air circulation system 216, and a temperature control system 218. As shown in FIG. 2, some or all of above-plant systems 210 may be mounted on an actuated platform 220 that is normally above plants that may be rooted in net pots 122. As shown in FIG. 2, above-plant lighting 212 directs light predominantly onto top surfaces of the plants, e.g., the top surfaces of leaves, and under-leaf lighting 130 directs light predominantly onto under surfaces of the plants, e.g., the bottom surfaces of leaves. Hydroponic system 200 can similarly provide both under-leaf gas tubes 135 for under-leaf gas supply or air circulation and above-plant system 216 for gas supply or air circulation, so that carbon-dioxide or other growth stimulating gases can be better supplied or flow from above and below plants.

A control system 220, which may be a programmable controller or electronic computing system, can collect measurements from sensors 230, communicate with other devices through a network (not shown), and control the subsystems of hydroponic system 200. In particular, sensors 230 may sense operating parameters of hydroponic system 200 such as atmospheric temperatures and compositions, the level, temperature, and composition of nutrient solution in reservoir 110, the levels of supply canisters (not shown) for gases and liquid plant nutrients, and the operating conditions of pumps, fans, and other subsystems of hydroponic system 200. Based on such measurements from sensors 230 and on user commands or the programming of control system 220, control system 220 may particularly control the intensity and spectrum of light from lighting systems 130 and 212 and the duty cycles, i.e., times or durations during which lighting systems 130 and 212 supply light. Control system 220 may further coordinate operations of subsystems such as lighting systems 130 and 212, gas lines 135, exhaust 216, heating or cooling systems 218, for example, to optimize plant growth.

A plant growth system that provides under-leaf lighting or gas supply may provide several benefits. In particular, plants can receive the correct light and carbon dioxide for photosynthesis on more of the plant's surface area because both top leaf surfaces and under-leaf surfaces may receive sufficient lighting and carbon-dioxide for photosynthesis. This may increase photosynthetic activities of the plant, encouraging growth and promoting plant health. Further, lower or inner plant leaves may still receive under-leaf lighting even when the leaves are shaded by the upper or outer leaves of the plant or shaded by other plants when multiple plants are grown in the same hydroponic system. The shaded leaves may thus receive more light than “normal” and may tend to grow larger and better. Shaded leaves, which might otherwise act as sinks of energy produced in the photosynthesis process, become sources of energy for plant growth. By introducing Photosynthetically Active Radiation (PAR) lighting or Photosynthetically Useable Radiation (PUR) lighting to lower leaves, there is a photosynthesis process in these leaves, allowing a sourcing in the photosynthetic process. Such lighting may lead to a better crop yield or plant growth.

Under-leaf lighting may also reduce the need to supplement lighting with reflector walls. Reflector walls may introduce heat bouncing off their surfaces and onto plants, block CO₂ flow to the plants, or restrict air flow from otherwise cooling the plants.

Although particular implementations have been disclosed, these implementations are only examples and should not be taken as limitations. Various adaptations and combinations of features of the implementations disclosed are within the scope of the following claims.

What is claimed is:

1. A hydroponic system comprising:
a plant fixture configured to hold roots of a plant; and
a first lighting system producing first light with a spectrum and intensity for photosynthesis in the growing plant, the first lighting system being positioned to direct the first light to an underside of the plant.

2. The system of claim 1, further comprising a second lighting system producing second light with a spectrum and intensity for photosynthesis in the growing plant, the second lighting system being positioned to direct the second light to a top side of the growing plant.

3. The system of claim 1, further comprising a tray on which a plurality of plant fixtures are mounted, wherein the first lighting system comprises light emitting diodes (LEDs) mounted on the tray between the plant fixtures.

4. The system of claim 3, wherein the LEDs are enclosed in strips adhered to the tray between rows or columns of the plant fixtures mounted on the tray.

5. The system of claim 3, further comprising a control system configured to operate the LEDs to produce lighting having a spectrum and an intensity that induces photosynthesis in the plant.

6. The system of claim 1, further comprising a gas tube positioned to provide gas flow under the plant.

7. The system of claim 6, wherein the gas tube supplies carbon dioxide to the underside of the plant.

8. A method for operating a hydroponic system comprising:
holding roots of a plant in a plant fixture; and
operating a light system adjacent to the plant fixture to illuminate an underside of the plant and to activate photosynthesis in the plant.

9. The method of claim 8, operating a gas tube adjacent to the plant fixture to direct a gas flow at the underside of the plant for the activate photosynthesis.

10. The method of claim 9, wherein operating the gas tube comprises supplying carbon dioxide from the gas tube to the underside of the plant.
